(19) United States
(12) Patent Application Publication
(10) Pub. No.: US 2024/0338708 A1
(43) Pub. Date: Oct. 10, 2024

(54) MANAGING PENDING DATA TRANSACTIONS

(71) Applicant: Motorola Mobility LLC, Chicago, IL (US)

(72) Inventors: Bhavana Bhat, Bangalore (IN); Amit Kumar Agrawal, Bangalore (IN); Hariprasad Shanbhogue Alampady, Bangalore (IN)

(73) Assignee: Motorola Mobility LLC, Chicago, IL (US)

(21) Appl. No.: 18/295,396

(22) Filed: Apr. 4, 2023

(51) Int. Cl. G06Q 20/40; G06Q 20/38

(52) U.S. Cl. CPC G06Q 20/407; G06Q 20/389

(57) ABSTRACT

Techniques for managing pending data transactions are described and are implementable to enable errant data transactions (e.g., payment transactions) to be detected and resolved. For instance, when a first data transaction is unresolved and remains pending for an excessive period, a second data transaction can be initiated and resolved successfully. The pending first data transaction may subsequently resolve successfully, and thus a result of the successful first data transaction can be reversed to avoid duplicate data transactions.

### BACKGROUND

The use of network-based payment systems has become commonplace across the world. For instance, users can pay for a large variety of goods and services using a network-based payment application, such as using a portable device, e.g., a smartphone. While the availability of payment applications can provide a great deal of convenience, it is not without challenges. For instance, payment transactions that involve data transfer over a network can encounter a number of issues, such as data corruption, data latency such as due to network congestion and/or network errors, service disruptions at a payment service, and so forth. Thus, a particular payment transaction may be delayed and/or fail completely. This can not only cause user inconvenience but can result in device and/or system disruption. For instance, operability of a user device may be reduced due to delayed resolution of a data transaction involving a payment. Further, payment service availability may be adversely affected due to unresolved data transactions relating to payment transfers.

### BRIEF DESCRIPTION OF THE DRAWINGS

Aspects of managing pending data transactions are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of managing pending data transactions can be implemented;

FIG. 2 illustrates an example inconclusive transaction record in accordance with one or more implementations;

FIG. 3A depicts an example system for managing pending data transactions in accordance with one or more implementations;

FIG. 3B depicts an example system for managing pending data transactions in accordance with one or more implementations;

FIG. 4 depicts an example system for managing pending data transactions in accordance with one or more implementations;

FIG. 5 depicts an example sender payment GUI in accordance with one or more implementations;

FIG. 6 depicts an example receiver payment GUI in accordance with one or more implementations;

FIG. 7 illustrates a flow chart depicting an example method for managing pending data transactions in accordance with one or more implementations;

FIG. 8 illustrates a flow chart depicting an example method for managing pending data transactions in accordance with one or more implementations;

FIG. 9 illustrates a flow chart depicting an example method for managing pending data transactions in accordance with one or more implementations;

FIG. 10 illustrates various components of an example device in which aspects of managing pending data transactions can be implemented in accordance with one or more implementations.

### DETAILED DESCRIPTION

Techniques for managing pending data transactions are described and are implementable to enable data transactions (e.g., payment transactions) to be correctly resolved. For instance the described techniques enable errors in payment transactions to be corrected to avoid system errors, such as incorrect resolution of payment transactions.

For instance, consider a scenario in which a user obtains a service from a service provider, such as a purchase of services and/or goods. To pay for the service, the user interacts with a payment application such as on their smartphone to create a transaction that is intended to transfer a value amount (e.g., a monetary amount) from the user's account to the service provider's account. Accordingly, the payment application generates a payment transaction to transfer the value amount from the user's account to the service provider's account and initiates a network process to attempt to complete the payment transaction.

However, delays and/or errors may occur at various points in the payment transaction process that can cause the payment transaction to “hang,” e.g., to remain pending for a longer than normal period of time. This can not only result in user inconvenience but can result in system errors and inefficient use of system resources. For instance, when the user observes that the payment transaction does not resolve for a period of time, the user may attempt to initiate a further payment transaction to pay for the service while the initial payment transaction remains unresolved. A number of errors may occur in such scenarios. For instance, the payment application may crash and/or enter an error state due to the duplicate transactions. Further, a payment processor involved in the payment transaction may generate an error when the payment processor detects the duplicate transactions. As yet another possibility, both payment transactions may eventually resolve with a transfer of the value amount to the service provider, which can result in an incorrect data representation of the payment transaction, e.g., a duplicate data transaction that results in a double transfer of the value amount from the user's account to the service provider's account.

Thus, such scenarios can cause system errors at various points in the transaction processing pipeline as well as inefficient use of system resources used to process the payment transaction and to attempt to correct the unresolved and/or incorrectly resolved payment transaction.

Accordingly, techniques described herein for managing pending data transactions can overcome these deficiencies in conventional systems by providing ways for enabling payment transactions to be correctly resolved when system lag and/or system errors occur. The described implementations, for example, include a transaction service that enables unresolved payment transactions to be detected and automatically resolved. For instance, consider a scenario such as described above where a user interacts with a payment application to initiate a first payment transaction for a service and the first payment transaction remains pending for more than a typical period of time. The user, wanting to resolve payment for the service, interacts with the payment application to initiate a second payment transaction for the service while the first payment transaction remains in a pending state.

Further to this example scenario, the second payment transaction resolves successfully, which includes a transfer of a value amount from the user's account to a service provider's account. However, subsequently to resolution of the second payment transaction, the first payment transaction finally resolves successfully which again results in a transfer of the value amount from the user's account to the service provider's account. Accordingly, unintended duplicate data transactions have occurred representing a data error, e.g., a duplicate transfer of the value amount from the user's account.

Accordingly, techniques described herein can implement automated reversal processes to reverse a result of the second payment transaction such that the overall data transaction is correctly concluded. For instance, in response to detecting that the first payment transaction successfully resolves after successful resolution of the second payment transaction, the transaction service can cause negotiation of the return of the value amount of the first payment transaction to the user's account. The transaction service, for instance, automatically monitors payment transactions, detects occurrence of the overlapping duplicate payment transactions, and initiates transaction reversal processes without users necessarily being aware that the reversal processes are initiated.

Implementations also provide ways for users to initiate revocation of payment transactions, such as when a payment transaction remains in a processing pending state for a longer than typical period of time. For instance, consider a scenario such as described above where a user initiates a first payment transaction for a service and the first payment transaction remains in a pending state for longer than normal. The transaction service can monitor a pending time of the first payment transaction and when the pending time exceeds a transaction pending condition, the transaction service can cause a revoke option to be presented. The transaction pending condition, for instance, represents a predefined threshold time period. Thus, the transaction service can present a selectable control on the user's device that is selectable to request that the first payment transaction be revoked.

Accordingly, in response to user selection of the selectable control, a revoke request can be sent to a payment provider's device. The transaction service, for instance, can interact with the payment provider's device and in response to receiving the revoke request, can cause selectable controls to be presented on the provider's device. For example, a first selectable control is selectable to accept (e.g., consent to) the revoke request and a second selectable control is selectable to deny the revoke request. In response to selection of the first selectable control, a revocation process can be implemented to cause the first payment transaction to be revoked, e.g., canceled. The user may then proceed with a second payment transaction to attempt to pay for the service. In response to selection of the second selectable control, however, the revocation request may be denied and the first payment transaction may remain in a pending state until the first payment transaction resolves successfully or fails.

In implementations and subsequent to consent to the revoke request, the second payment transaction may successfully resolve and result in a transfer of a value amount from the user's account to the service provider's account. The first payment transaction (e.g., the revoked transaction) may subsequently resolve successfully and also result in a transfer of the value amount from the user's account to the service provider's account. Based at least in part on consent by the service provider for revocation of the first payment transaction, the transaction service may initiate a reversal process to reverse a result of the successful first payment transaction, examples of which are described throughout this disclosure.

Accordingly, techniques described herein enable detection and correction of errant (e.g., duplicate) data transactions. In implementations, a payment transaction represents a data transaction. For instance, digital payment transactions involve generating, transmitting, and processing various types of data and across a variety of different systems and networks. Thus, such digital payment transactions can be characterized as sets of computational operations much like other operations of a computing device and/or set of computing devices. Accordingly, by enabling the detection and correction of errant data transactions, the described techniques can conserve system resources (e.g., memory, processor bandwidth, network bandwidth, etc.) that may otherwise be used to detect and correct such data transactions, and thus the described techniques can improve the operation of computing devices and data networks. Further, user burden can be reduced by performing such corrective processes automatically while reducing user interaction to initiate and manage the corrective processes.

While features and concepts of managing pending data transactions can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

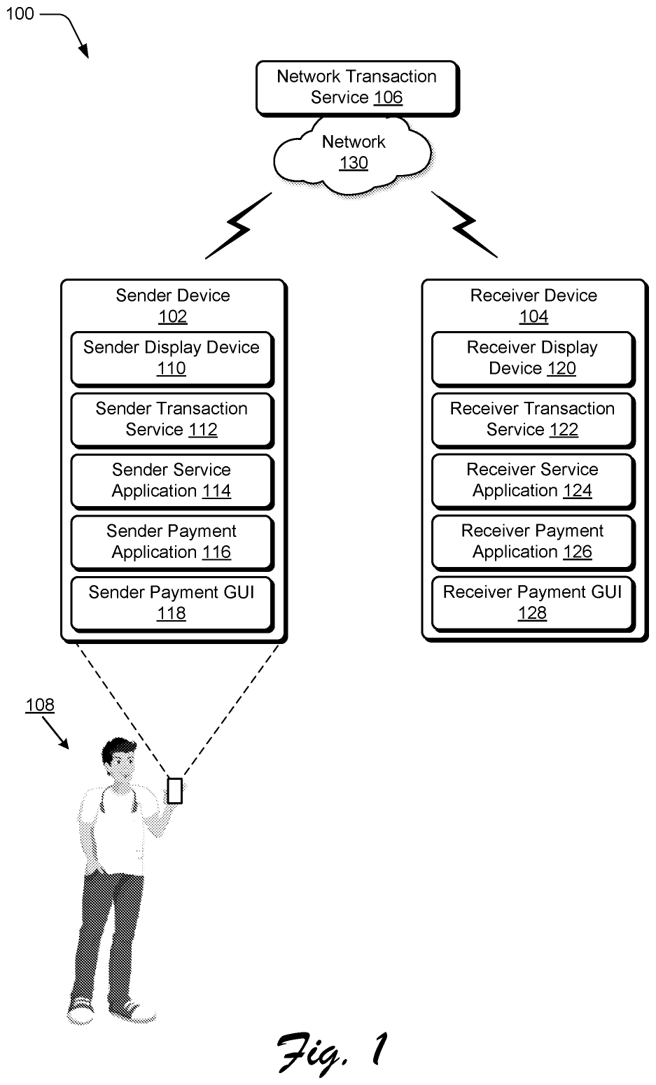

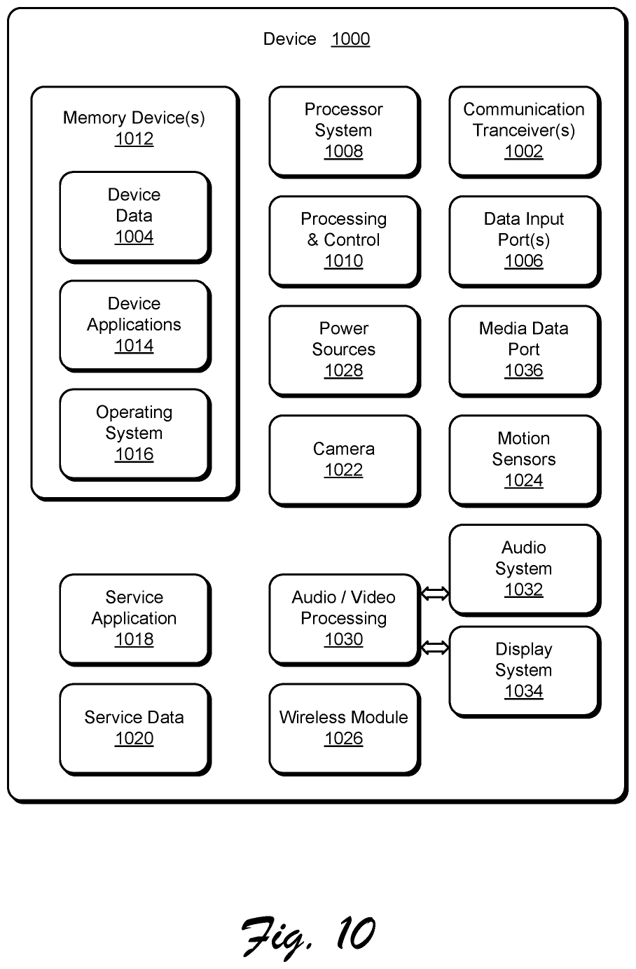

FIG. 1 illustrates an example environment 100 in which aspects of managing pending data transactions can be implemented. The environment 100 includes a sender device 102, a receiver device 104, and a network transaction service 106. The sender device 102 represents a device that can used such as by a user 108 to send digital payments, such as to the receiver device 104. The receiver device 104, for instance, represents a device that can receive payments such as from the sender device 102. The sender device 102 and the receiver device 104 can be implemented in various ways and include various functionality, examples of which are discussed below with reference to the example device 1000 of FIG. 10.

The sender device 102 includes various functionality such as a sender display device 110, a sender transaction service 112, a sender service application 114, a sender payment application 116, and a sender payment graphical user interface (GUI) 118. The sender display device 110 represents functionality for graphic output by the sender device 102. Further, the sender display device 110 can include touch input functionality, such as to enable the user 108 to provide input to the sender device 102 via touch input to the sender display device 110.

The sender transaction service 112 and the sender service application 114 represent functionality for performing various aspects of managing pending data transactions in accordance with one or more implementations. The sender transaction service 112, for instance, represents functionality for enabling resolution of inconclusive transactions on behalf of the sender device 102. The sender service application 114 represents functionality for initiating payment transactions, such as based on user input to the sender device 102.

The sender payment application 116 represents functionality for initiating different stages of payment transactions, such as payment transaction initiation and payment reversal processes. The sender payment GUI 118 represents a GUI that can be output via the sender display device 110 to enable the user to initiate payment transactions, view payment transaction status, and to perform different actions pertaining to payment transactions.

The receiver device 104 includes various functionality such as a receiver display device 120, a receiver transaction service 122, a receiver service application 124, a receiver payment application 126, and a receiver GUI 128. The receiver display device 110 represents functionality for graphic output by the receiver device 104. Further, the receiver display device 120 can include touch input functionality, such as to enable a user associated with the receiver device 104 to provide input to the receiver device 104 via touch input to the receiver display device 120.

The receiver transaction service 122 and the receiver service application 124 represent functionality for performing various aspects of managing pending data transactions in accordance with one or more implementations. The receiver transaction service 122, for instance, represents functionality for enabling resolution of inconclusive transactions on behalf of the receiver device 104. The receiver service application 124 represents functionality for receiving payment transactions, such as from the sender device 102.

The receiver payment application 126 represents functionality for participating in different stages of payment transactions, such as receiving payment transaction initiation from the sender device 102 and payment reversal processes. The receiver payment GUI 128 represents a GUI that can be output via the receiver display device 120 to enable a user to view payment transaction status (e.g., incoming payment transactions) and to perform different actions pertaining to payment transactions.

The network transaction service 106 represents a service that is connected to a network 130 and that can participate in various processes pertaining to managing pending data transactions. The sender device 102 and the receiver device 104, for instance, can interact as part of different stages of payment transactions and payment reversal processes via the network transaction service 106. The network 130 represents a wireless and/or wired network to which the sender device 102 and the receiver device 104 can connect, such as to enable data communication between the sender device 102 and the receiver device 104 as part of implementations for managing pending data transactions discussed herein.

Having discussed an example environment in which the disclosed techniques can be performed, consider now some example scenarios and implementation details for implementing the disclosed techniques.

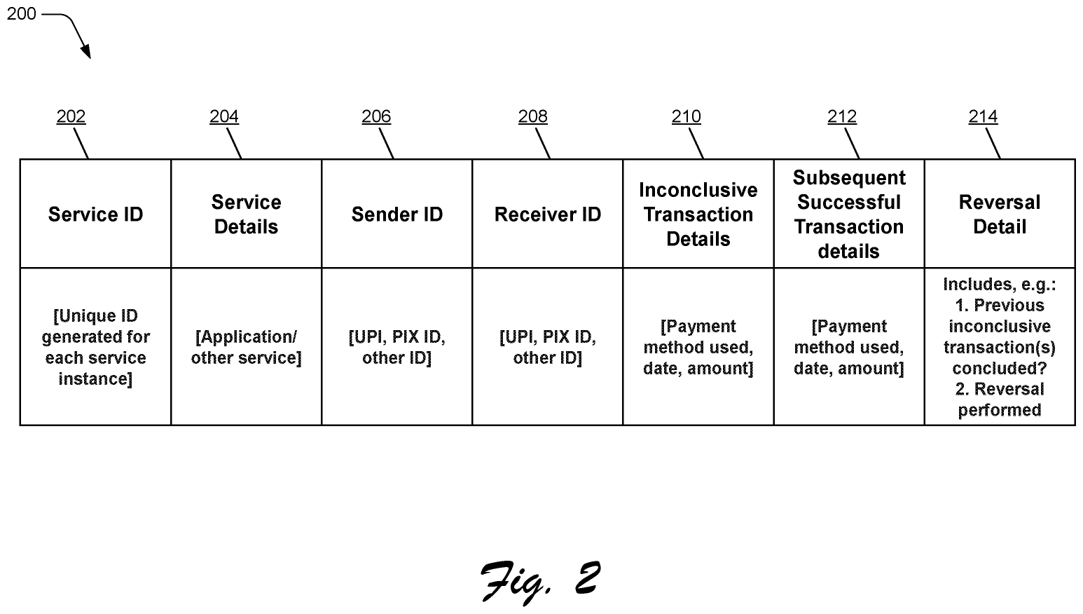

FIG. 2 illustrates an example inconclusive transaction record 200 in accordance with one or more implementations. The inconclusive transaction record 200, for instance, can be generated in response to occurrence of an inconclusive transaction and can be used to tag various data transmissions pertaining to the inconclusive transaction. The inconclusive transaction record 200 includes different fields that are used to track different information types for inconclusive transactions including:

Service ID Field 202: In implementations a service ID is generated for each payment transaction and the service ID field 202 can be populated with the service ID. For instance, the service ID can be used to correlate multiple transactions to a single service instance, such as where a second payment transaction for a service is initiated after a first payment transaction for the service is inconclusive. In implementations a single service ID can remain valid and tagged to multiple payment transactions that are associated with a single service instance, such as until each of the multiple payment transactions are determined to be concluded.

Service Details Field 204: This field includes information about a service upon which a particular payment transaction is based, such as a service provider name, an application to which the payment transaction was directed, a payment provider, and so forth.

Sender ID Field 206: This field includes an ID for a sender (e.g., a sender device) that initiates a payment transaction. Any suitable ID can be utilized, such as a unified payments interface (UPI) ID, a Pix ID, device identifier, etc.

Receiver ID Field 208: This field includes an ID for a receiver (e.g., a receiver device) that is to receive a payment transaction. Any suitable ID can be utilized, such as a UPI ID, Pix ID, device identifier, etc.

Inconclusive Transaction Details Field 210: This field includes information about an inconclusive payment transaction, such as a payment method used, a date that the transaction was initiated, an amount of the transaction, and so forth.

Successful Transaction Details Field 212: This field includes information about a successful payment transaction that occurs subsequently to an inconclusive payment transaction described in the inconclusive transaction details field 210. Example information that can be included in this field includes payment method used, a date that the transaction was initiated, an amount of the transaction, and so forth.

Reversal Detail Field 214: This field includes information about transaction reversals based on inconclusive transactions and subsequent successful transactions. Examples of information included in this field include whether an identified inconclusive transaction subsequently concluded (e.g., was subsequently successful after a subsequent successful transaction), whether a reversal of the subsequently successful inconclusive transaction was attempted and/or successful, and so forth.

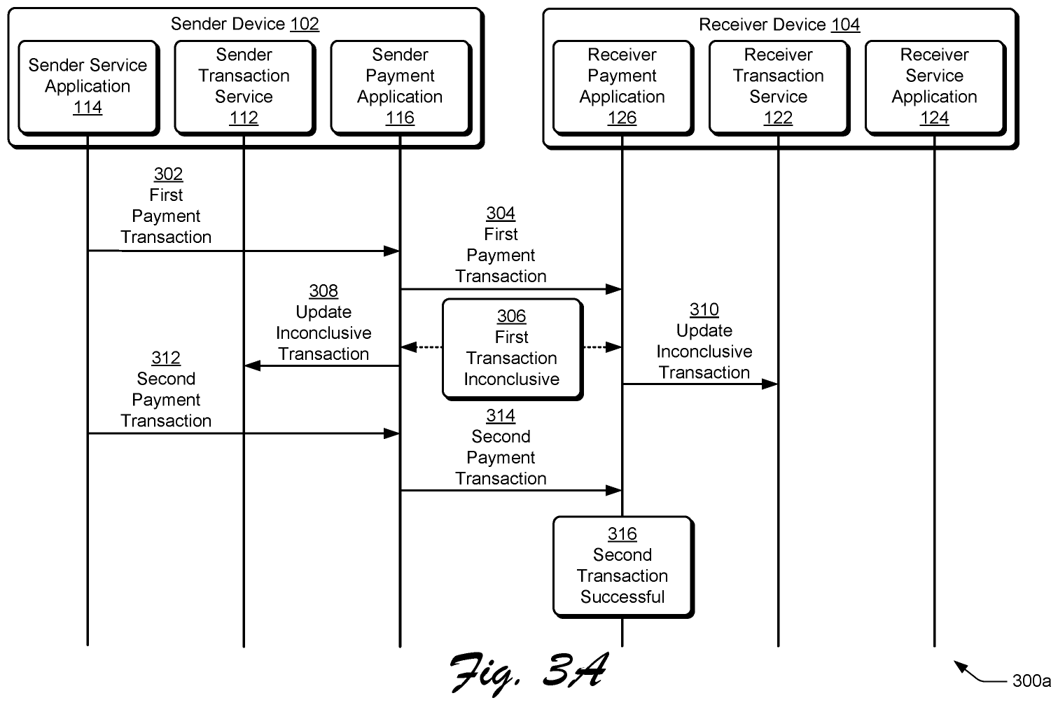

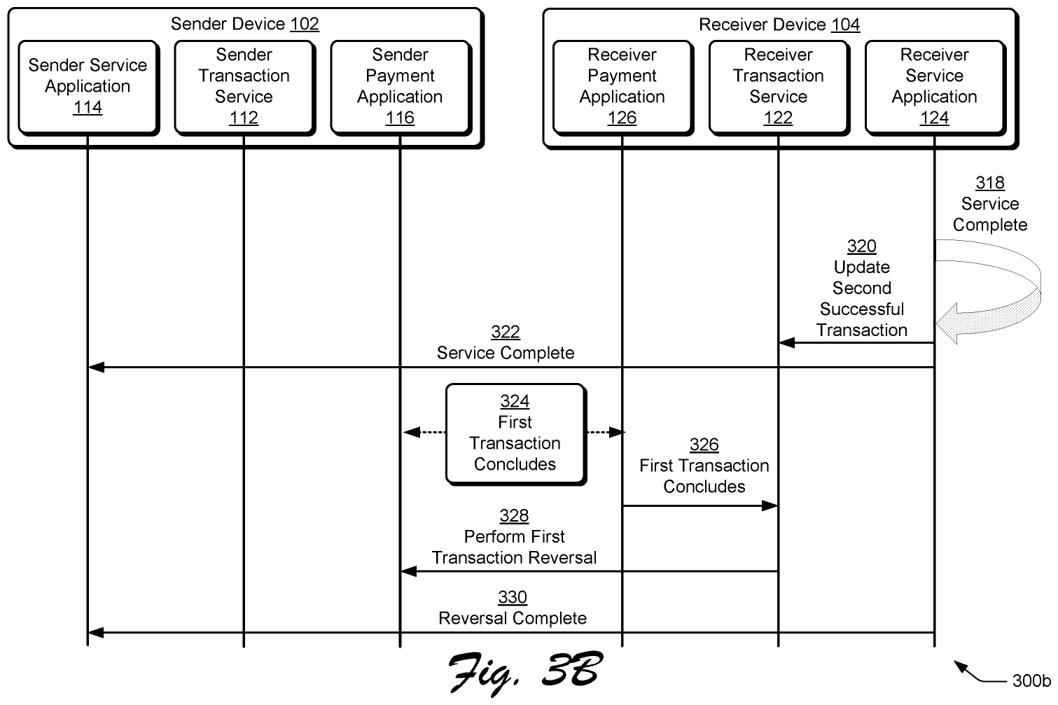

FIG. 3A depicts an example system 300a for managing pending data transactions in accordance with one or more implementations. The system 300a can be implemented in the environment 100 and incorporates attributes of the environment 100 introduced above. The communications described in the system 300a can be tagged with various identifiers, such as the service ID discussed above with reference to the inconclusive transaction record 200 and/or the inconclusive transaction record 200 itself. In the system 300a at 302 the sender service application 114 initiates a first payment transaction to the sender payment application 116. The user 108, for instance, interacts with the sender device 102 to initiate a payment transaction to the receiver device 104, such as based on goods and/or services received by the user 108.

At 304 the sender payment application 116 transmits the first payment transaction to the receiver payment application 126 and at 306 it is determined that the first payment transaction is inconclusive. The first payment transaction, for instance, fails to be properly transmitted to the receiver device 104 or the first payment transaction encounter a processing delay at some point in the payment processing pipeline at. According, at 308 the sender payment application updates the sender transaction service 112 that the first payment transaction is inconclusive and at 310 the receiver payment application updates the receiver transaction service 122 that the first payment transaction is inconclusive.

Further to the system 300a at 312 the sender payment application 114 initiates a second payment transaction to the sender payment application 116. The user 108, for instance, initiates the second payment transaction based on determining that the first payment transaction fails to conclude within a typical period of time, e.g., is still pending after a period of time. At 314 the sender payment application 116 transmits the second payment transaction to the receiver payment application 126 and at 316 the second payment transaction is successful.

FIG. 3B depicts an example system 300b for managing pending data transactions in accordance with one or more implementations. The system 300b can be implemented in the environment 100 and incorporates attributes of the environment 100 introduced above. The system 300a, for instance, represents a continuation of the system 300b. Further, the communications described in the system 300b can be tagged with various identifiers, such as the service ID discussed above with reference to the inconclusive transaction record 200 and/or the inconclusive transaction record 200 itself.

In the system 300b and based at least in part on the second payment transaction being successful, at the 318 the service is indicated at being complete, e.g., payment for the original service is indicated as being successfully received by the receiver device 104. Accordingly, at 320 the receiver service application 124 updates the receiver transaction service 122 of the successful second payment transaction and at 322 the receiver service application 124 notifies the sender service application 114 of the service completion.

Further to the system 300b at 324 the first payment transaction (the inconclusive transaction) concludes, e.g., is successful. Thus, the first payment transaction is successful subsequent to the second payment transaction being successful. At 326 the receiver payment application 126 notifies the receiver transaction service 122 that the first payment transaction concludes, and at 328 the receiver transaction service 122 initiates and performs a reversal process for reversing the first payment transaction. The reversal process, for instance, involves transferring a payment amount of the first payment transaction back to a user of the sender device 102, e.g., to the sender payment application 116. Accordingly, based on success of the reversal process, at 330 the receiver service application notifies the sender service application 114 that the reversal process is complete, e.g., that a result of successful completion of the first payment transaction is reversed.

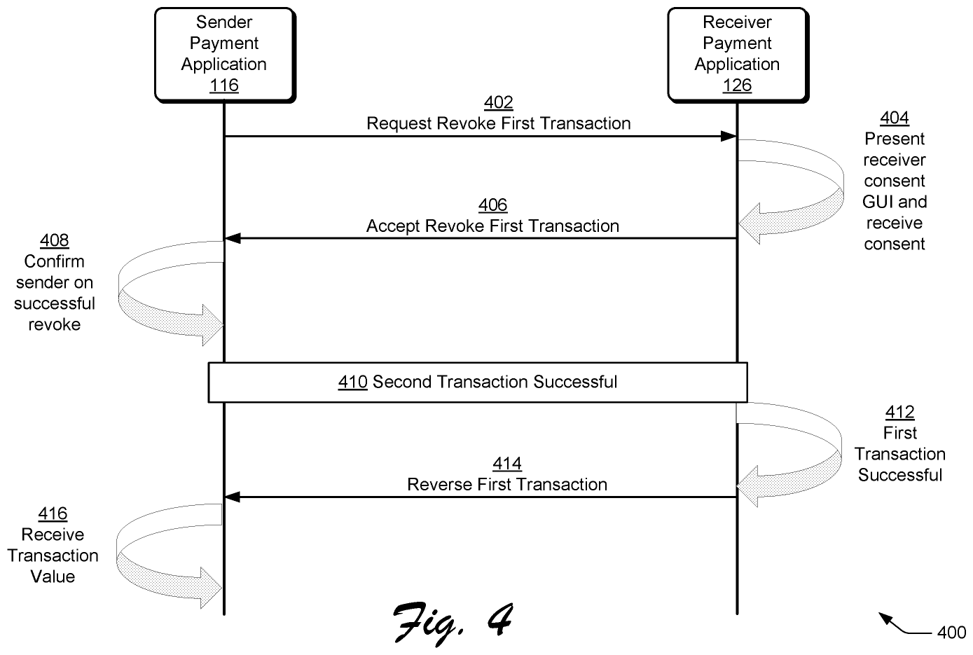

FIG. 4 depicts an example system 400 for managing pending data transactions in accordance with one or more implementations. The system 400 can be implemented in the environment 100 and incorporates attributes of the environment 100 introduced above. In at least some implementations the different communications described in the system 400 can be tagged with various identifiers, such as the service ID discussed above with reference to the inconclusive transaction record 200 and/or the inconclusive transaction record 200 itself.

In the system 400, at 402 a request to revoke a first payment transaction is transmitted from the sender payment application 116 to the receiver payment application 126. A user, for instance, interacts with the sender payment application 116 at the sender device 102 to request that a particular transaction be revoked, such as via a GUI presented at the sender device 102. The user can request that the first payment transaction be revoked for various reasons, such as due to an excessive pending time of the first payment transaction, e.g., the first payment transaction is inconclusive.

For example, if the first payment transaction is pending (e.g., not concluded) for at least a threshold period of time, the sender payment application 116 can automatically present a GUI that enables a user to interact with the GUI to request revocation of the first payment transaction. In implementations and as part of the request to revoke the first payment transaction, a screenshot of the GUI can be captured at the sender device 102 and transmitted along with the request to revoke to the receiver device 104, e.g., to enable a user of the receiver device 104 to verify that the request to revoke is initiated by a legitimate entity such as a user of the sender device 102.

At 404 a receiver consent GUI is presented that enables a receiver user associated with the payment receiver application 126 to provide consent to the request to revoke the first payment transaction, and the receiver user interacts with the consent GUI to provide consent. In at least one implementation the receiver payment application 126 represents and/or includes the consent GUI.

Further to the system 400 at 406 the receiver payment application 126 transmits an indication of receiver acceptance of the request to revoke the first payment transaction to the sender payment application 116, and at 408 the sender payment application 116 confirms successful revocation of the first payment transaction with the sender. At 410 the sender payment application 116 initiates a second payment transaction with the receiver payment application 126, e.g., a second payment transaction for a same service for which the first payment transaction was initiated. The second payment transaction is successful. At 412 the first payment transaction is successful (e.g., after the successful second payment transaction), and at 414 and based at least in part on the receiver's consent to revocation of the first payment transaction, the receiver payment application 126 performs a reversal process of the first payment transaction. At 416 the sender payment application receives the value of the first payment transaction, e.g., a return of payment received by the receiver payment application 126 based on the successful first payment transaction.

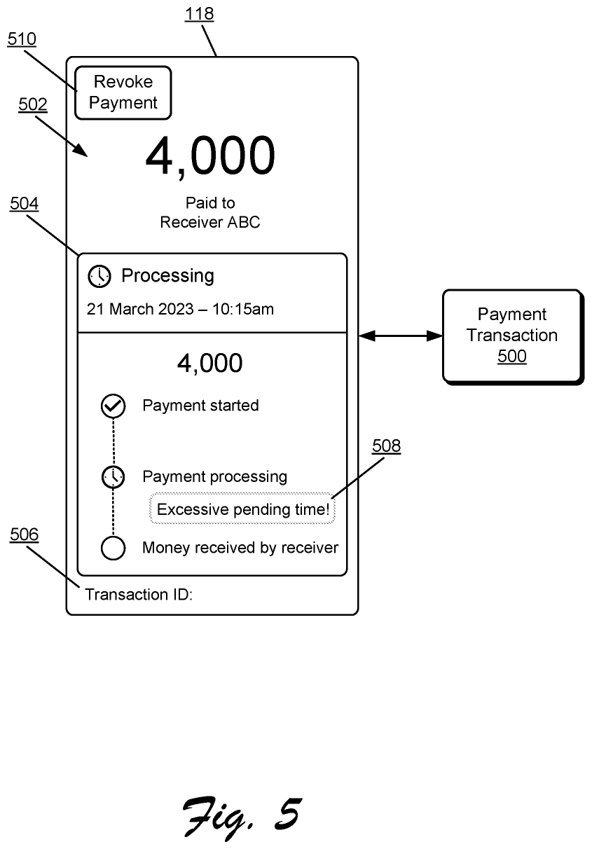

FIG. 5 depicts an example sender payment GUI 118 in accordance with one or more implementations. The sender payment GUI 118, for instance, is presented via the sender device 102 and enables a user to initiate and manage a payment transaction 500. The sender payment GUI 118 may be generated, presented, and/or managed by the sender payment application 116, the sender service application 114, and/or cooperatively between the sender payment application 116 and the sender service application 114.

The sender payment GUI 118 includes a transaction amount region 502, a transaction status region 504, and a transaction ID 506. The transaction amount region 502 indicates a payment amount of the payment transaction 500 and an identifier for a receiving party of the payment transaction 500, e.g., a party associated with the receiver device 104. The transaction status region 504 indicates a status of the payment transaction 500, which in this particular example indicates that the payment transaction 500 has started and is currently processing. The transaction ID 506 includes an ID that is assigned to the payment transaction 500. In at least one implementation the transaction ID 506 can include and/or correspond to the service ID introduced above.

In this particular example the payment transaction 500 has exceeded a pending time threshold, e.g., a threshold amount of time that the payment transaction 500 is in a pending and/or processing state. Accordingly, a pending time alert 508 is presented in the transaction status region 504 indicating excessive transaction pending time. Further, a revoke payment control 510 is presented that is selectable to initiate a revoke payment process with a payment receiver, e.g., the receiver device 104. The sender payment application 116 and/or the sender service application 114, for instance, monitor a transaction pending time and when the pending time exceeds a pending time threshold, the pending time alert 508 and the revoke payment control 510 are presented.

Accordingly, a user can select the revoke payment control 510 to initiate a transaction revocation process to attempt to revoke (e.g., invalidate) the payment transaction 500, such as detailed in the system 400. For instance, selecting the revoke payment control 510 causes a request to be transmitted to the receiver device 104 requesting revocation of the payment transaction 500. Further, in response to selection of the revoke payment control 510, a screenshot of the sender device 102 (e.g., the sender payment GUI 118) can be captured and transmitted to the receiver device 104 for display, such as part of a verification process that the request to revoke is initiated by an authorized and/or trusted party, e.g., a user of the sender device 102.

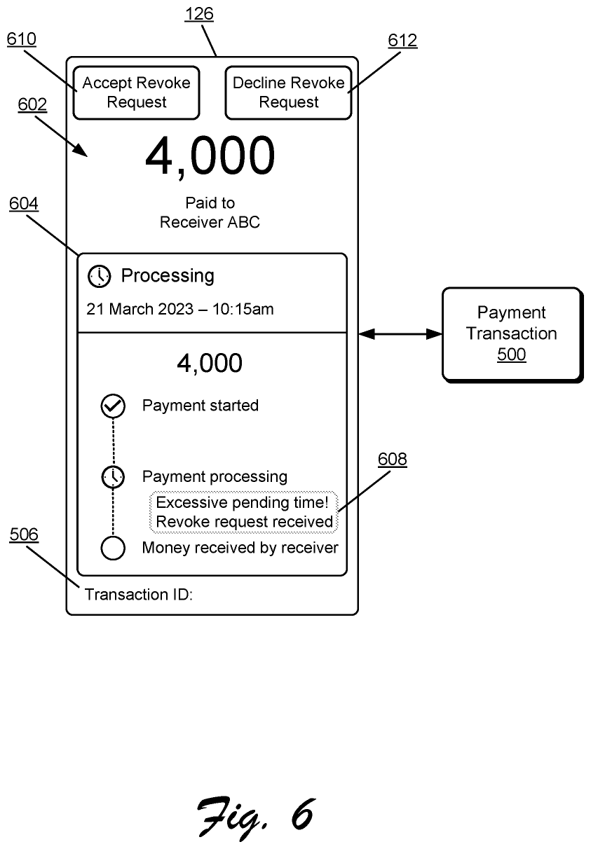

FIG. 6 depicts an example receiver payment GUI 128 in accordance with one or more implementations. The receiver payment GUI 128, for instance, is presented via the receiver device 104 and enables a user to manage and view a status of the payment transaction 500 discussed above. The receiver payment GUI 128 may be generated, presented, and/or managed by the receiver payment application 126, the receiver service application 124, and/or cooperatively between the receiver payment application 126 and the receiver service application 124.

The receiver payment GUI 128 includes a transaction amount region 602, a transaction status region 604, and the transaction ID 506. The transaction amount region 602 indicates a payment amount of the payment transaction 500 and an identifier for the receiving party of the transaction, e.g., a party associated with the receiver device 104. The transaction status region 604 indicates a status of the payment transaction 500, which in this particular example indicates that the payment transaction 500 has started and is currently processing. The transaction ID 506 includes an ID that is assigned to the transaction, which in at least one implementation is the same transaction ID presented in the sender payment GUI 118. In at least one implementation the transaction ID 506 can include and/or correspond to the service ID introduced above.

In this particular example the payment transaction 500 has exceeded a pending time threshold, e.g., a threshold amount of time that the payment transaction 500 is in a pending and/or processing state. Accordingly, a pending time alert 608 is presented in the transaction status region 604 indicating excessive transaction pending time. Further, the pending time alert 608 indicates that the sender has requested to revoke the payment transaction 500, e.g., a revoke request is received from the sender device 102. Further, an option to view a screenshot from the sender device 102 (e.g., of the sender payment GUI 118) can be presented, such as to enable a user of the receiver device 104 to verify that the request to revoke originated from an authorized and/or trusted party, e.g., a user of the sender device 102.

Accordingly, an accept control 610 and a decline control 612 are presented within the receiver payment GUI 128. The accept control 610, for instance, is selectable to accept the request to revoke the payment transaction 500, e.g., to cause a payment transaction revocation process to be initiated. The decline control 612 is selectable to decline the request the revoke the payment transaction 500. For instance, in response to selection of the decline control 612, the payment transaction 500 can remain in a processing state such as until the transaction concludes successfully or fails. According to implementations, selection of the accept control 610 causes a notification to be transmitted from the receiver device 104 to the sender device 102 indicating that the receiver device 104 has accepted the request to revoke the payment transaction 500. Further, selection of the decline control 612 causes a notification to be transmitted from the receiver device 104 to the sender device 102 indicating that the receiver device 104 has declined the request to revoke the payment transaction 500.

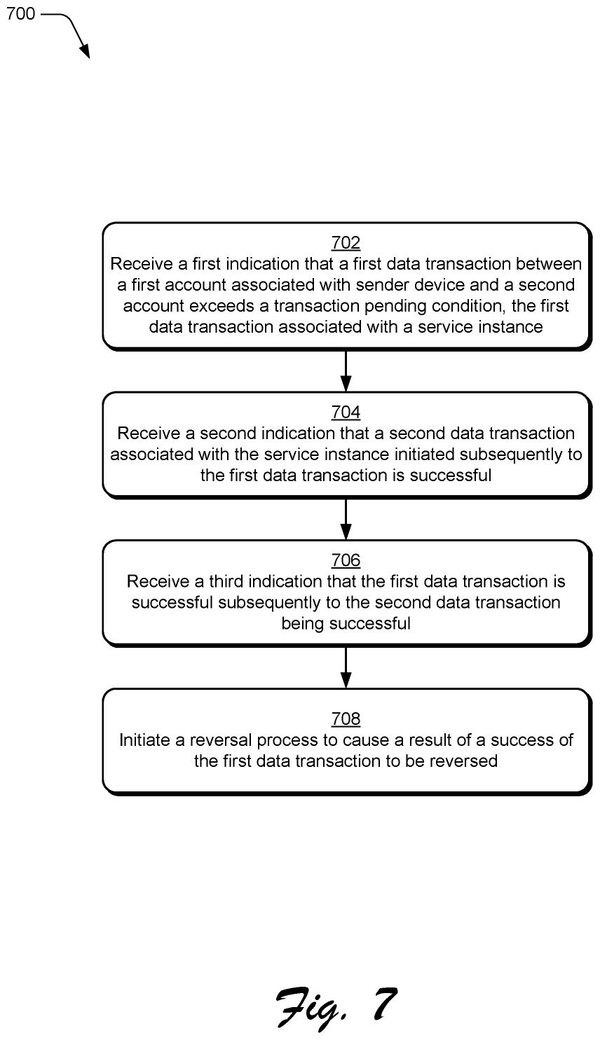

FIG. 7 illustrates a flow chart depicting an example method 700 for managing pending data transactions in accordance with one or more implementations. Operations of the method 700 may be performed at the sender device 102, the receiver device 104, the network transaction service 106, and/or cooperatively between one or more combinations of these entities.

At 702 a first indication is received that a first data transaction between a first account associated with sender device and a second account exceeds a transaction pending condition, the first data transaction associated with a service instance. A user, for instance, interacts with the sender payment application 116 to initiate a payment transaction for a service, such as a purchase of goods, services, etc. The payment transaction, for instance, represents a data transaction at least based on the notion that data is generated and communicated in response to initiation of the payment transaction. Further, the transaction pending condition can correspond to a threshold pending time of a data transaction. Thus, the first data transaction can be initiated and pending for a period of time that equals or exceeds the threshold pending time.

At 704 a second indication is received that a second data transaction associated with the service instance initiated subsequently to the first data transaction is successful. For instance, a second payment transaction is initiated in response to the first payment transaction exceeding the transaction pending condition. The second payment transaction can be initiated in various ways, such as based on user input to initiate the second payment transaction, automatically by the sender payment application 116 in response to detecting that the first payment transaction exceeds the transaction pending condition, and so forth. Further, the first payment transaction remains in a pending state while the second payment transaction is pending and concludes successfully. For instance, the second payment transaction is successful and results in a transfer of value, such as a digital value (e.g., monetary) exchange from a sender user account to a receiver user account.

At 706 a third indication is received that the first data transaction is successful subsequently to the second data transaction being successful. For instance, after the second payment transaction concludes successfully, the first payment transaction concludes successfully. For instance, a transfer of value occurs based on success of the first payment transaction, such as from the sender user account to the receiver user account.

At 708 a reversal process is initiated to cause a result of a success of the first data transaction to be reversed. For instance, the success of the second payment transaction and subsequently the first payment transaction can result in a situation where a double payment is made for a particular service. Accordingly, the reversal process can cause value transferred from a sender account to a receiver account as part of the first payment transaction to be retransferred back to the sender account.

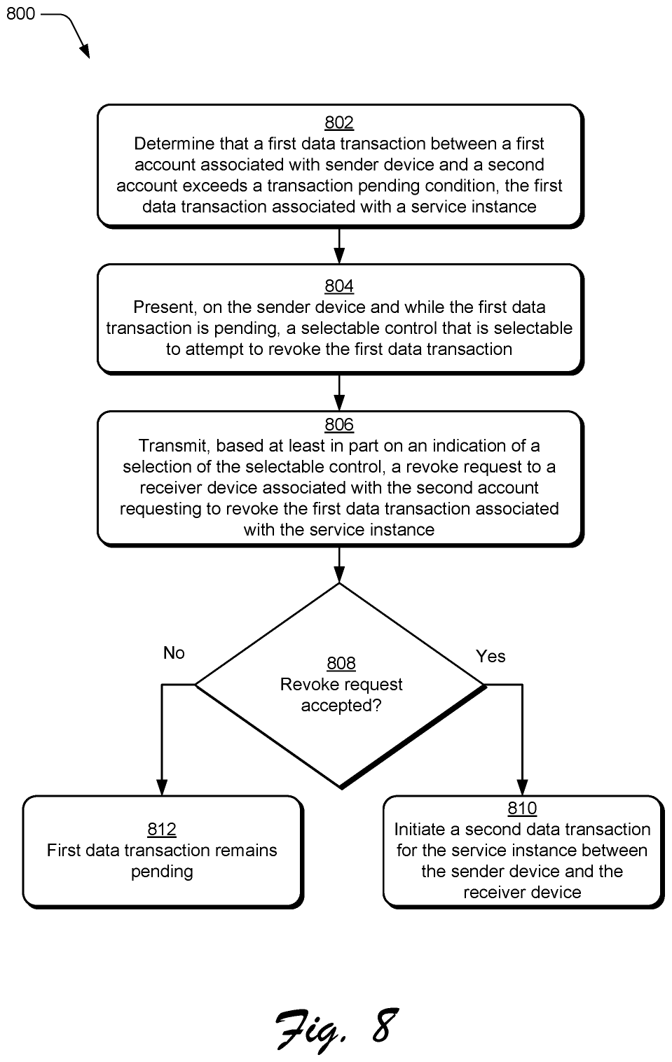

FIG. 8 illustrates a flow chart depicting an example method 800 for managing pending data transactions in accordance with one or more implementations. Operations of the method 800 may be performed at the sender device 102, the network transaction service 106, and/or cooperatively between the two.

At 802 it is determined that a first data transaction between a first account associated with sender device and a second account exceeds a transaction pending condition, the first data transaction associated with a service instance. In at least one implementation the first account is associated with the sender device 102 and the second account is associated with the receiver device 104. The first data transaction, for instance, represents a payment transaction initiated via the first account and such as via the sender payment application 116.

At 804, on the sender device and while the first data transaction is pending, a selectable control is presented that is selectable to attempt to revoke the first data transaction. For instance, in response to the first payment transaction exceeding the transaction pending condition, a selectable control is presented on the sender device 102 that is selectable to initiate a request to revoke the first payment transaction.

At 806, based at least in part on an indication of a selection of the selectable control, a revoke request is transmitted to a receiver device associated with the second account requesting to revoke the first data transaction associated with the service instance. A user, for instance, interacts with the sender device 102 and selects the selectable control, and the sender device 102 transmits a revoke request to the receiver device 104 requesting to consent to revocation of the first payment transaction.

At 808 it is determined whether the revoke request is accepted. The sender device sender device 102, for instance, receives a response from the receiver device 104 based on the revoke request indicating whether an account associated with the receiver device 104 accepts or denies the revoke request. If the revoke request is accepted (“Yes”), at 810 a second data transaction is initiated for the service instance between the sender device and the receiver device. The sender payment application 116, for instance, initiates a second payment transaction, such as while the first payment transaction remains in a pending state. As discussed above, the first payment transaction and the second payment transaction can be tagged with a common service ID and can be for equivalent value amounts.

If the revoke request is denied (“No”), at 812 the first data transaction remains pending. The first payment transaction, for instance, remains pending until the first payment transaction concludes successfully or fails.

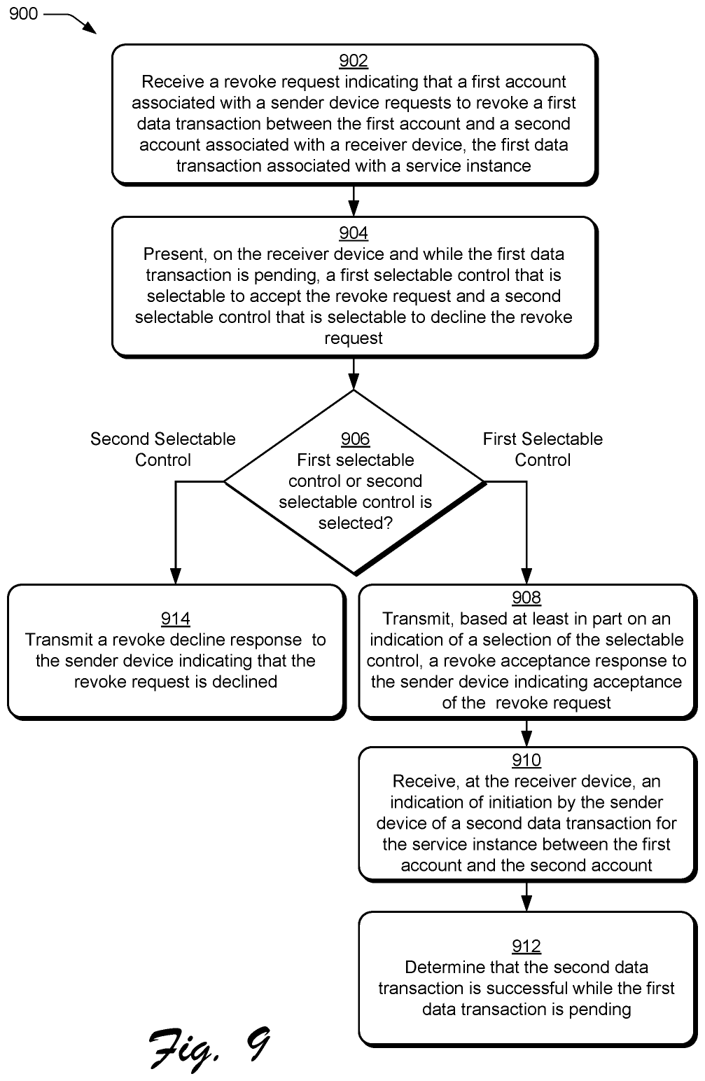

FIG. 9 illustrates a flow chart depicting an example method 900 for managing pending data transactions in accordance with one or more implementations. Operations of the method 900 may be performed at the receiver device 104, the network transaction service 106, and/or cooperatively between the two.

At 902 a revoke request is received indicating that a first account associated with a sender device requests to revoke a first data transaction between the first account and a second account associated with a receiver device, the first data transaction associated with a service instance. The receiver device 104, for instance, receives the revoke request to revoke a first payment transaction from the sender device 102.

At 904, on the receiver device and while the first data transaction is pending, a first selectable control is presented that is selectable to accept the revoke request and a second selectable control is presented that is selectable to decline the revoke request. The first selectable control and the second selectable control, for instance, are presented as part of the receiver payment GUI 128.

At 906 it is determined whether the first selectable control or the second selectable control is selected. If the first selectable control is selected (“First Selectable Control”), at 908, based at least in part on an indication of a selection of the first selectable control, a revoke acceptance response is transmitted to the sender device indicating acceptance of the revoke request. The receiver device 104, for instance, transmits the revoke acceptance response to the sender device 102 indicating acceptance of the request to initiate revocation of the first payment transaction.

At 910, at the receiver device, an indication is received of initiation by the sender device of a second data transaction for the service instance between the first account and the second account. A user, for instance, interacts with the sender payment GUI 118 to initiate a second payment transaction, and the receiver device 104 is notified of initiation of the second payment transaction. At 912 it is determined that the second data transaction is successful while the first data transaction is pending. The receiver device 104, for instance, determines that the second payment transaction is successful, such as based on a value amount of the second payment transaction being credited to an account associated with the receiver device 104. As discussed throughout this disclosure, the first payment transaction may subsequently conclude successfully and thus a revocation process may be implemented to reverse a result of the successful conclusion of the first payment transaction.

Returning to 906, if the second selectable control is selected (“Second Selectable Control”), at 914, based at least in part on an indication of a selection of the second selectable control, a revoke decline response is transmitted to the sender device 102 indicating that the revoke request is declined. The receiver device 104, for instance, transmits the revoke decline response to the sender device 102 indicating that the receiver device 104 declines the request to initiate revocation of the first payment transaction. Accordingly, a revocation process for the first payment transaction may not be initiated and the first payment transaction may remain pending such as until the first payment transaction concludes successfully or fails.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 10 illustrates various components of an example device 1000 in which aspects of managing pending data transactions can be implemented. The example device 1000 can be implemented as any of the devices described with reference to the previous FIGS. 1-9, such as any type of mobile device, mobile phone, mobile device, wearable device, tablet, computing, communication, entertainment, gaming, media playback, and/or other type of electronic device. For example, the sender device 102 and/or the receiver device 104 as shown and described with reference to FIGS. 1-9 may be implemented as the example device 1000.

The device 1000 includes communication transceivers 1002 that enable wired and/or wireless communication of device data 1004 with other devices. The device data 1004 can include any of device identifying data, device location data, wireless connectivity data, and wireless protocol data. Additionally, the device data 1004 can include any type of audio, video, and/or image data. Example communication transceivers 1002 include wireless personal area network (WPAN) radios compliant with various IEEE 1002.15 (Bluetooth™) standards, wireless local area network (WLAN) radios compliant with any of the various IEEE 1002.10 (Wi-Fi™) standards, wireless wide area network (WWAN) radios for cellular phone communication, wireless metropolitan area network (WMAN) radios compliant with various IEEE 1002.16 (WiMAX™) standards, and wired local area network (LAN) Ethernet transceivers for network data communication.

The device 1000 may also include one or more data input ports 1006 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1000 includes a processing system 1008 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 1010. The device 1000 may further include any type of a system bus or other data and command transfer system that couples the various components within the device. A system bus can include any one or combination of different bus structures and architectures, as well as control and data lines.

The device 1000 also includes computer-readable storage memory 1012 (e.g., memory devices) that enable data storage, such as data storage devices that can be accessed by a computing device, and that provide persistent storage of data and executable instructions (e.g., software applications, programs, functions, and the like). Examples of the computer-readable storage memory 1012 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1000 may also include a mass storage media device.

The computer-readable storage memory 1012 provides data storage mechanisms to store the device data 1004, other types of information and/or data, and various device applications 1014 (e.g., software applications). For example, an operating system 1016 can be maintained as software instructions with a memory device and executed by the processing system 1008. The device applications may also include a device manager, such as any form of a control application, software application, signal-processing and control module, code that is native to a particular device, a hardware abstraction layer for a particular device, and so on. Computer-readable storage memory 1012 represents media and/or devices that enable persistent and/or non-transitory storage of information in contrast to mere signal transmission, carrier waves, or signals per se. Computer-readable storage memory 1012 do not include signals per se or transitory signals.

In this example, the device 1000 includes a service application 1018 that implements aspects of managing pending data transactions and may be implemented with hardware components and/or in software as one of the device applications 1014. For example, the service application 1018 can be implemented as one or more of the sender service application 114 or the receiver service application 124 described in detail above. In implementations, the service application 1018 may include independent processing, memory, and logic components as a computing and/or electronic device integrated with the device 1000. The device 1000 also includes service data 1020 for implementing aspects of managing pending data transactions and may include data from the service application 1018, such as data for managing inconclusive transactions.

In this example, the example device 1000 also includes a camera 1022 and motion sensors 1024, such as may be implemented in an inertial measurement unit (IMU). The motion sensors 1024 can be implemented with various sensors, such as a gyroscope, an accelerometer, and/or other types of motion sensors to sense motion of the device. The various motion sensors 1024 may also be implemented as components of an inertial measurement unit in the device.

The device 1000 also includes a wireless module 1026, which is representative of functionality to perform various wireless communication tasks. The device 1000 can also include one or more power sources 1028, such as when the device is implemented as a mobile device. The power sources 1028 may include a charging and/or power system, and can be implemented as a flexible strip battery, a rechargeable battery, a charged super-capacitor, and/or any other type of active or passive power source.

The device 1000 also includes an audio and/or video processing system 1030 that generates audio data for an audio system 1032 and/or generates display data for a display system 1034. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1036. In implementations, the audio system and/or the display system are integrated components of the example device. Alternatively, the audio system and/or the display system are external, peripheral components to the example device.

Although implementations of managing pending data transactions have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In addition to the previously described methods, any one or more of the following:

In some aspects, the techniques described herein relate to a system including: one or more processors; and computer-readable storage media storing instructions that are executable by the one or more processors to: receive a first indication that a first data transaction between a first account associated with sender device and a second account exceeds a transaction pending condition, the first data transaction associated with a service instance; receive a second indication that a second data transaction associated with the service instance initiated subsequently to the first data transaction is successful; receive a third indication that the first data transaction is successful subsequently to the second data transaction being successful; and initiate a reversal process to cause a result of a success of the first data transaction to be reversed.

In some aspects, the techniques described herein relate to a system, wherein the first data transaction includes a first payment transaction and the second data transaction includes a second payment transaction of an equivalent value to the first payment transaction.

In some aspects, the techniques described herein relate to a system, wherein the instructions are executable by the one or more processors to tag the first service transaction and the second service transaction with a same service identifier.

In some aspects, the techniques described herein relate to a system, wherein the instructions are executable by the one or more processors to generate a transaction record for the first data transaction and populate the transaction record with first information for the first data transaction, second information for the second data transaction, and third information for the reversal process.

In some aspects, the techniques described herein relate to a system, wherein the instructions are executable by the one or more processors to generate the transaction record in response to the first indication that the first data transaction exceeds the transaction pending condition.

In some aspects, the techniques described herein relate to a system, wherein the first information includes an indication of whether the first data transaction is concluded subsequently to the second data transaction.

In some aspects, the techniques described herein relate to a system, wherein to cause the result of the success of the first data transaction to be reversed, the instructions are executable by the one or more processors to cause a value amount of the first data transaction to be transferred from the second account to the first account.

In some aspects, the techniques described herein relate to a system, wherein the instructions are executable by the one or more processors to: cause, while the first data transaction is pending, a selectable control to be presented on the sender device, the selectable control being selectable to request to revoke the first data transaction; cause, in response to selection of the selectable control, a revoke request to be transmitted from the sender device to a receiver device associated with the second account; and cause the first data transaction to be revoked in response to receipt of acceptance of the revoke request.

In some aspects, the techniques described herein relate to a system, wherein the instructions are executable by the one or more processors to: cause, in response to selection of the selectable control, a screenshot from the sender device to be captured; and cause the screenshot to be transmitted to the receiver device in conjunction with transmission of the revoke request.

In some aspects, the techniques described herein relate to a system, wherein the instructions are executable by the one or more processors to initiate the reversal process automatically in response to the third indication and independent of user input to initiate the reversal process.

In some aspects, the techniques described herein relate to a system including: one or more processors; and computer-readable storage media storing instructions that are executable by the one or more processors to: determine that a first data transaction between a first account associated with sender device and a second account exceeds a transaction pending condition, the first data transaction associated with a service instance; present, on the sender device and while the first data transaction is pending, a selectable control that is selectable to attempt to revoke the first data transaction; transmit, based at least in part on an indication of a selection of the selectable control, a revoke request to a receiver device associated with the second account requesting to revoke the first data transaction associated with the service instance; receive an indication of an acceptance of the revoke request; and initiate a second data transaction for the service instance between the sender device and the receiver device.

In some aspects, the techniques described herein relate to a system, wherein the instructions are executable by the one or more processors to generate a transaction record for the first data transaction and populate the transaction record with first information for the first data transaction, second information for the second data transaction, third information for a reversal process for reversing the first data transaction, and fourth information indicating that the revoke request was transmitted to the receiver device and whether the revoke request was accepted.

In some aspects, the techniques described herein relate to a system, wherein the instructions are executable by the one or more processors to: capture, in response to the indication of the selection of the selectable control, a screenshot from the sender device; and transmit the screenshot to the receiver device in conjunction with the revoke request.

In some aspects, the techniques described herein relate to a system, wherein the instructions are executable by the one or more processors to initiate the second data transaction while the first data transaction is in a pending state.

In some aspects, the techniques described herein relate to a system, wherein the instructions are executable by the one or more processors to: receive a first indication indicating that the second data transaction is successful; receive, subsequent to the first indication, a second indication indicating that the first data transaction is successful; and cause a reversal process to be initiated to reverse a result of a success of the first data transaction to be reversed.

In some aspects, the techniques described herein relate to a system, wherein the instructions are executable by the one or more processors to tag the first data transaction and the second data transaction with a common service identifier.

In some aspects, the techniques described herein relate to a system including: one or more processors; and computer-readable storage media storing instructions that are executable by the one or more processors to: receive a revoke request indicating that a first account associated with a sender device requests to revoke a first data transaction between the first account and a second account associated with a receiver device, the first data transaction associated with a service instance; present, on the receiver device and while the first data transaction is pending, a selectable control that is selectable to accept the revoke request; transmit, based at least in part on an indication of a selection of the selectable control, a revoke acceptance response to the sender device indicating acceptance of the revoke request; receive, at the receiver device, an indication of initiation by the sender device of a second data transaction for the service instance between the first account and the second account; and determine that the second data transaction is successful while the first data transaction is pending.

In some aspects, the techniques described herein relate to a system, wherein the instructions are executable by the one or more processors to present, on the receiver device and while the first data transaction is pending, a different selectable control that is selectable to decline the revoke request.

In some aspects, the techniques described herein relate to a system, wherein the instructions are executable by the one or more processors to: receive, in conjunction with the revoke request, a screenshot from the sender device including an image of a graphical user interface (GUI) used to initiate the revoke request; and output the screenshot on the receiver device.

In some aspects, the techniques described herein relate to a system, wherein the instructions are executable by the one or more processors to: determine that the first data transaction is successful subsequently to the success of the second data transaction; and cause a reversal process to be initiated to reverse a result of a success of the first data transaction to be reversed.

In some aspects, the techniques described herein relate to a method including: receiving a first indication that a first data transaction between a first account associated with sender device and a second account exceeds a transaction pending condition, the first data transaction associated with a service instance; receiving a second indication that a second data transaction associated with the service instance initiated subsequently to the first data transaction is successful; receiving a third indication that the first data transaction is successful subsequently to the second data transaction being successful; and initiating a reversal process to cause a result of a success of the first data transaction to be reversed.

In some aspects, the techniques described herein relate to a method, wherein the first data transaction includes a first payment transaction and the second data transaction includes a second payment transaction of an equivalent value to the first payment transaction.

In some aspects, the techniques described herein relate to a method, further including tagging the first service transaction and the second service transaction with a same service identifier.

In some aspects, the techniques described herein relate to a method, further including generating a transaction record for the first data transaction and populating the transaction record with first information for the first data transaction, second information for the second data transaction, and third information for the reversal process.

In some aspects, the techniques described herein relate to a method, further including generating the transaction record in response to the first indication that the first data transaction exceeds the transaction pending condition.

In some aspects, the techniques described herein relate to a method, wherein the first information includes an indication of whether the first data transaction is concluded subsequently to the second data transaction.

In some aspects, the techniques described herein relate to a method, wherein causing the result of the success of the first data transaction to be reversed includes causing a value amount of the first data transaction to be transferred from the second account to the first account.

In some aspects, the techniques described herein relate to a method, further including: causing, while the first data transaction is pending, a selectable control to be presented on the sender device, the selectable control being selectable to request to revoke the first data transaction; causing, in response to selection of the selectable control, a revoke request to be transmitted from the sender device to a receiver device associated with the second account; and causing the first data transaction to be revoked in response to receipt of acceptance of the revoke request.

In some aspects, the techniques described herein relate to a method, further including: causing, in response to selection of the selectable control, a screenshot from the sender device to be captured; and causing the screenshot to be transmitted to the receiver device in conjunction with transmission of the revoke request.

In some aspects, the techniques described herein relate to a method, further including initiating the reversal process automatically in response to the third indication and independent of user input to initiate the reversal process.

In some aspects, the techniques described herein relate to a method including: determining that a first data transaction between a first account associated with sender device and a second account exceeds a transaction pending condition, the first data transaction associated with a service instance; presenting, on the sender device and while the first data transaction is pending, a selectable control that is selectable to attempt to revoke the first data transaction; transmitting, based at least in part on an indication of a selection of the selectable control, a revoke request to a receiver device associated with the second account requesting to revoke the first data transaction associated with the service instance; receiving an indication of an acceptance of the revoke request; and initiating a second data transaction for the service instance between the sender device and the receiver device.

In some aspects, the techniques described herein relate to a method, further including generating a transaction record for the first data transaction and populating the transaction record with first information for the first data transaction, second information for the second data transaction, third information for a reversal process for reversing the first data transaction, and fourth information indicating that the revoke request was transmitted to the receiver device and whether the revoke request was accepted.

In some aspects, the techniques described herein relate to a method, further including: capturing, in response to the indication of the selection of the selectable control, a screenshot from the sender device; and transmitting the screenshot to the receiver device in conjunction with the revoke request.

In some aspects, the techniques described herein relate to a method, further including initiating the second data transaction while the first data transaction is in a pending state.

In some aspects, the techniques described herein relate to a method, further including: receiving a first indication indicating that the second data transaction is successful; receiving, subsequent to the first indication, a second indication indicating that the first data transaction is successful; and causing a reversal process to be initiated to reverse a result of a success of the first data transaction to be reversed.

In some aspects, the techniques described herein relate to a method, further including tagging the first data transaction and the second data transaction with a common service identifier.

In some aspects, the techniques described herein relate to a method including: receiving a revoke request indicating that a first account associated with a sender device requests to revoke a first data transaction between the first account and a second account associated with a receiver device, the first data transaction associated with a service instance; presenting, on the receiver device and while the first data transaction is pending, a selectable control that is selectable to accept the revoke request; transmitting, based at least in part on an indication of a selection of the selectable control, a revoke acceptance response to the sender device indicating acceptance of the revoke request; receiving, at the receiver device, an indication of initiation by the sender device of a second data transaction for the service instance between the first account and the second account; and determining that the second data transaction is successful while the first data transaction is pending.

In some aspects, the techniques described herein relate to a method, further including presenting, on the receiver device and while the first data transaction is pending, a different selectable control that is selectable to decline the revoke request.

In some aspects, the techniques described herein relate to a method, further including: receiving, in conjunction with the revoke request, a screenshot from the sender device including an image of a graphical user interface (GUI) used to initiate the revoke request; and outputting the screenshot on the receiver device.

In some aspects, the techniques described herein relate to a method, further including: determining that the first data transaction is successful subsequently to the success of the second data transaction; and causing a reversal process to be initiated to reverse a result of a success of the first data transaction to be reversed.

1. A system comprising:
one or more processors; and
computer-readable storage media storing instructions that are executable by the one or more processors to:
receive a first indication that a first data transaction between a first account associated with sender device and a second account exceeds a transaction pending condition, the first data transaction associated with a service instance;
receive a second indication that a second data transaction associated with the service instance initiated subsequently to the first data transaction is successful;
receive a third indication that the first data transaction is successful subsequently to the second data transaction being successful; and
initiate a reversal process to cause a result of a success of the first data transaction to be reversed.

2. The system of claim 1, wherein the first data transaction comprises a first payment transaction and the second data transaction comprises a second payment transaction of an equivalent value to the first payment transaction.

3. The system of claim 1, wherein the instructions are executable by the one or more processors to tag the first service transaction and the second service transaction with a same service identifier.

4. The system of claim 1, wherein the instructions are executable by the one or more processors to generate a transaction record for the first data transaction and populate the transaction record with first information for the first data transaction, second information for the second data transaction, and third information for the reversal process.

5. The system of claim 4, wherein the instructions are executable by the one or more processors to generate the transaction record in response to the first indication that the first data transaction exceeds the transaction pending condition.

6. The system of claim 4, wherein the first information comprises an indication of whether the first data transaction is concluded subsequently to the second data transaction.

7. The system of claim 1, wherein to cause the result of the success of the first data transaction to be reversed, the instructions are executable by the one or more processors to cause a value amount of the first data transaction to be transferred from the second account to the first account.

8. The system of claim 1, wherein the instructions are executable by the one or more processors to:
cause, while the first data transaction is pending, a selectable control to be presented on the sender device, the selectable control being selectable to request to revoke the first data transaction;
cause, in response to selection of the selectable control, a revoke request to be transmitted from the sender device to a receiver device associated with the second account; and
cause the first data transaction to be revoked in response to receipt of acceptance of the revoke request.

9. The system of claim 8, wherein the instructions are executable by the one or more processors to:
cause, in response to selection of the selectable control, a screenshot from the sender device to be captured; and
cause the screenshot to be transmitted to the receiver device in conjunction with transmission of the revoke request.

10. The system of claim 1, wherein the instructions are executable by the one or more processors to initiate the reversal process automatically in response to the third indication and independent of user input to initiate the reversal process.

11. A system comprising:
one or more processors; and
computer-readable storage media storing instructions that are executable by the one or more processors to:
determine that a first data transaction between a first account associated with sender device and a second account exceeds a transaction pending condition, the first data transaction associated with a service instance;
present, on the sender device and while the first data transaction is pending, a selectable control that is selectable to attempt to revoke the first data transaction;
transmit, based at least in part on an indication of a selection of the selectable control, a revoke request to a receiver device associated with the second account requesting to revoke the first data transaction associated with the service instance;
receive an indication of an acceptance of the revoke request; and
initiate a second data transaction for the service instance between the sender device and the receiver device.

12. The system of claim 11, wherein the instructions are executable by the one or more processors to generate a transaction record for the first data transaction and populate the transaction record with first information for the first data transaction, second information for the second data transaction, third information for a reversal process for reversing the first data transaction, and fourth information indicating that the revoke request was transmitted to the receiver device and whether the revoke request was accepted.

13. The system of claim 11, wherein the instructions are executable by the one or more processors to:
capture, in response to the indication of the selection of the selectable control, a screenshot from the sender device; and
transmit the screenshot to the receiver device in conjunction with the revoke request.

14. The system of claim 11, wherein the instructions are executable by the one or more processors to initiate the second data transaction while the first data transaction is in a pending state.

15. The system of claim 11, wherein the instructions are executable by the one or more processors to:
receive a first indication indicating that the second data transaction is successful;
receive, subsequent to the first indication, a second indication indicating that the first data transaction is successful; and
cause a reversal process to be initiated to reverse a result of a success of the first data transaction to be reversed.

16. The system of claim 11, wherein the instructions are executable by the one or more processors to tag the first data transaction and the second data transaction with a common service identifier.

17. A system comprising:
one or more processors; and
computer-readable storage media storing instructions that are executable by the one or more processors to:
receive a revoke request indicating that a first account associated with a sender device requests to revoke a first data transaction between the first account and a second account associated with a receiver device, the first data transaction associated with a service instance;
present, on the receiver device and while the first data transaction is pending, a selectable control that is selectable to accept the revoke request;
transmit, based at least in part on an indication of a selection of the selectable control, a revoke acceptance response to the sender device indicating acceptance of the revoke request;
receive, at the receiver device, an indication of initiation by the sender device of a second data transaction for the service instance between the first account and the second account; and
determine that the second data transaction is successful while the first data transaction is pending.

18. The system of claim 17, wherein the instructions are executable by the one or more processors to present, on the receiver device and while the first data transaction is pending, a different selectable control that is selectable to decline the revoke request.

19. The system of claim 17, wherein the instructions are executable by the one or more processors to:
receive, in conjunction with the revoke request, a screenshot from the sender device including an image of a graphical user interface (GUI) used to initiate the revoke request; and
output the screenshot on the receiver device.

20. The system of claim 17, wherein the instructions are executable by the one or more processors to:
determine that the first data transaction is successful subsequently to the success of the second data transaction; and
cause a reversal process to be initiated to reverse a result of a success of the first data transaction to be reversed.
